(19) United States
(12) Patent Application Publication
(10) Pub. No.: US 2026/0087771 A1
(43) Pub. Date: Mar. 26, 2026

(54) OBJECT RECOGNITION METHOD AND APPARATUS, ELECTRONIC DEVICE, STORAGE MEDIUM, AND PROGRAM PRODUCT

(71) Applicant: Tencent Technology (Shenzhen) Company Limited, Shenzhen (CN)

(72) Inventors: Yihao Lan, Shenzhen (CN); Shuo Zhong, Shenzhen (CN)

(73) Assignee: Tencent Technology (Shenzhen) Company Limited, Shenzhen (CN)

(21) Appl. No.: 19/215,621

(22) Filed: May 22, 2025

Related U.S. Application Data
(63) Continuation of application No. PCT/CN2024/082209, filed on Mar. 18, 2024.

(30) Foreign Application Priority Data
May 16, 2023 (CN) 202310553485.6

(51) Int. Cl. G06V 10/70; G06T 7/13; G06T 7/40

(52) U.S. Cl. CPC G06V 10/70; G06T 7/13; G06T 7/40

(57) ABSTRACT

An object recognition method of an electronic device includes displaying a recognition control for performing augmented reality recognition on a to-be-recognized object; displaying a recognition interface in response to a trigger operation for the recognition control; performing a first augmented reality recognition operation on the to-be-recognized object based on the to-be-recognized object existing on the recognition interface, and displaying a recognition effect of the to-be-recognized object; and displaying an augmented reality recognition result of the to-be-recognized object based on the first augmented reality recognition operation being completed.

### CROSS-REFERENCE TO RELATED APPLICATIONS

This application is a continuation application of International Application No. PCT/CN2024/082209 filed on Mar. 18, 2024, which claims priority to Chinese Patent Application No. 202310553485.6 filed with the China National Intellectual Property Administration on May 16, 2023, the disclosures of each being incorporated by reference herein in their entireties.

### FIELD

The disclosure relates to the field of mobile Internet technologies, and to an object recognition method and apparatus, an electronic device, a storage medium, and a program product.

### BACKGROUND

An augmented reality (AR) recognition technology is a computer technology that combines virtual information with the real world to create an AR experience. In the AR recognition technology, an image, a sound, or the like (which is collectively referred to as a to-be-recognized object) in the real world is captured or recognized by using a camera, a sensor, or another device, and is combined with virtual content generated by a computer, to enhance the sensory experience of a user.

In a recognition process of a to-be-recognized object, only a locating prompt is provided for the to-be-recognized object to indicate that the to-be-recognized object is being recognized. As a result, the recognition process is boring, and the utilization rate of a graphics processing resource in a device is low.

### SUMMARY

According to an aspect of the disclosure, an object recognition method of an electronic device includes displaying a recognition control for performing augmented reality recognition on a to-be-recognized object; displaying a recognition interface in response to a trigger operation for the recognition control; performing a first augmented reality recognition operation on the to-be-recognized object based on the to-be-recognized object existing on the recognition interface, and displaying a recognition effect of the to-be-recognized object; and displaying an augmented reality recognition result of the to-be-recognized object based on the first augmented reality recognition operation being completed.

According to an aspect of the disclosure, an object recognition apparatus includes at least one memory configured to store computer program code; and at least one processor configured to read the program code and operate as instructed by the program code, the program code includes first display code configured to cause at least one of the at least one processor to display a recognition control for performing augmented reality recognition on a to-be-recognized object; second display code configured to cause at least one of the at least one processor to display a recognition interface in response to a trigger operation for the recognition control; third display code configured to cause at least one of the at least one processor to perform a first augmented reality recognition operation on the to-be-recognized object based on the to-be-recognized object existing on the recognition interface; and display a recognition effect of the to-be-recognized object; and fourth display code configured to cause at least one of the at least one processor to display an augmented reality recognition result of the to-be-recognized object based on the first augmented reality recognition operation being completed.

According to an aspect of the disclosure, a non-transitory computer-readable storage medium, storing computer code which, when executed by at least one processor, causes the at least one processor to at least display a recognition control for performing augmented reality recognition on a to-be-recognized object; display a recognition interface in response to a trigger operation for the recognition control; perform a first augmented reality recognition operation on the to-be-recognized object based on the to-be-recognized object existing on the recognition interface; display a recognition effect of the to-be-recognized object; and display an augmented reality recognition result of the to-be-recognized object based on the first augmented reality recognition operation being completed.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic architecture diagram of an object recognition system according to some embodiments.

FIG. 2 is a schematic structural diagram of an electronic device according to some embodiments.

FIG. 3 is a flowchart of an object recognition method according to some embodiments.

FIG. 4 is a schematic diagram of displaying of a recognition effect according to some embodiments.

FIG. 5 is a schematic diagram of displaying of a recognition interface according to some embodiments.

FIG. 6 is a schematic diagram of obtaining of an outlined image according to some embodiments.

FIG. 7 is a schematic diagram of object recognition according to some embodiments.

FIG. 8 is a schematic diagram of displaying of a recognition effect according to some embodiments.

FIG. 9 is a schematic diagram of a Sober operator according to some embodiments.

FIG. 10 is a schematic diagram of a spatial domain convolution operation according to some embodiments.

FIG. 11 is a schematic diagram of edge detection according to some embodiments.

FIG. 12 is a schematic diagram of displaying of an outlined image according to some embodiments.

FIG. 13 is a schematic diagram of fluctuation stretching according to some embodiments.

FIG. 14 is a schematic diagram of a pixel coordinate offset function according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In some embodiments, user information and other related data (for example, interaction data or the like for a to-be-recognized object when the to-be-recognized object is itself or work of a user) are involved. When some embodiments are applied to products or technologies, user permission or consent may be used, and acquisition, use, and processing of the related data should comply with relevant laws, regulations, and standards of relevant countries and regions.

In the following descriptions, related “some embodiments” describe a subset of all some embodiments. The “some embodiments” may be the same subset or different subsets of all some embodiments, and may be combined with each other without conflict.

In the following descriptions, the related term “second, . . . ” is intended to distinguish between similar objects rather than represent a particular sequence of the objects. A particular sequence or a chronological order indicated by “second, . . . ” may be changed, so that some embodiments described herein can be implemented in a sequence other than the sequence illustrated or described herein.

Unless otherwise defined, meanings of all technical and scientific terms used in the disclosure are the same as those understood by a person skilled in the art to which the disclosure belongs. Terms used herein are intended to describe some embodiments, but are not intended to limit the disclosure.

Before some embodiments are further described in detail, a description is made on nouns and terms in some embodiments, and the nouns and terms in some embodiments are applicable to the following explanations.
(1) Client: It is an application that runs in a terminal and is used for providing various services, such as a recognition client, a search client, an instant messaging client.
2) Being in response to: It is used for representing a condition or state on which a performed operation depends. When the dependent condition or state is satisfied, one or more operations performed may be in real time or may have a set delay. Without being stated, there is no limitation to the order in which the operations are performed.

Some embodiments provide an object recognition method and apparatus, an electronic device, a computer-readable storage medium, and a computer program product, which can add an effect element in a recognition process, improves the interestingness of the recognition process, and improves the utilization rate of a graphic processing resource. The following will describe exemplary applications of the electronic device according to some embodiments. The electronic device according to some embodiments may be implemented as various types of user terminals such as a notebook computer, a tablet computer, a desktop computer, a set-top box, a mobile device (for example, a mobile phone, a portable music player, a personal digital assistant, a dedicated message device, and a portable game device), a smart phone, a smart speaker box, a smart watch, a smart TV, an in-vehicle terminal, and an augmented reality (AR) device, or may be implemented as a server. An exemplary application in which a device is implemented as a terminal is described below.

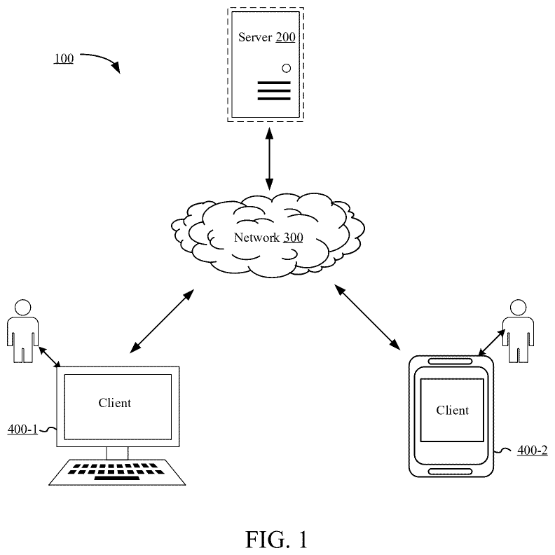

FIG. 1 is a schematic architecture diagram of an object recognition system 100 according to some embodiments. To implement supporting of an exemplary application, terminals (a terminal 400-1 and a terminal 400-2 are illustratively shown) are connected to a server 200 through a network 300. The network 300 may be a wide area network or a local area network, or a combination of the wide area network and the local area network.

In some embodiments, the server 200 may be an independent physical server, or may be a server cluster including a plurality of physical servers or a distributed system, or may be a cloud server providing cloud computing services, such as a cloud service, a cloud database, cloud computing, a cloud function, cloud storage, a network service, cloud communication, a middleware service, a domain name service, a security service, a content delinetwork (CDN), big data, and an artificial intelligence platform. The terminal and the terminal may be connected directly or indirectly to the server in a wired or wireless communication protocol, which is not limited in some embodiments.

During actual applications, clients such as a recognition client, a search client, and an instant messaging client are arranged on the terminals. The clients have an augmented reality recognition (for example AR recognition) function. When a user opens a client in a terminal to perform AR recognition, a recognition control for performing augmented reality recognition on a to-be-recognized object is displayed, and a recognition interface is displayed in response to a trigger operation for the recognition control. When the to-be-recognized object exists in the recognition interface, the terminal transmits an acquired image corresponding to the acquired to-be-recognized object to the server 200. The server 200 performs an augmented reality (AR) recognition operation on the to-be-recognized object based on the acquired image, generates a recognition effect according to the acquired image in the process of performing the augmented reality recognition operation, and returns the recognition effect to the terminal for displaying. When completing the augmented reality recognition operation, the server 200 obtains an augmented reality recognition result of the to-be-recognized object, and returns the augmented reality recognition result to the terminal for displaying.

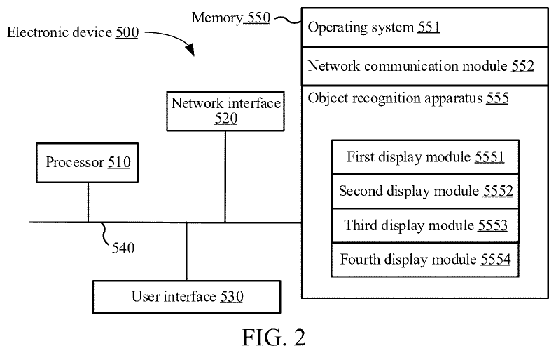

FIG. 2 is a schematic structural diagram of an electronic device 500 according to some embodiments. An example is used in which the electronic device 500 is the terminal in FIG. 1. The electronic device 500 shown in FIG. 2 includes: at least one processor 510, a memory 550, at least one network interface 520, and a user interface 530. The various components in the electronic device 500 are coupled together by using a bus system 540. The bus system 540 is configured to implement connection and communication between the components. In addition to a data bus, the bus system 540 further includes a power bus, a control bus, and a state signal bus. For clarity of description, all types of buses in FIG. 2 are marked as the bus system 540.

The processor 510 may be an integrated circuit chip having a signal processing capability, for example, a central processing unit (CPU), a digital signal processor (DSP), another programmable logic device, discrete gate or transistor logic device, or discrete hardware component, or the like. The purpose processor may be a microprocessor or any processor, or the like.

The memory 550 includes a volatile memory or a non-volatile memory, or may include both a volatile memory and a non-volatile memory. The non-volatile memory may be a read-only memory (ROM). The volatile memory may be a random access memory (RAM). The memory 550 described in some embodiments is to include various types of memories. The memory 550 includes one or more storage devices away from the processor 510 in physical positions.

In some embodiments, the memory 550 may store data to support various operations. Examples of the data include a program, a module, and a data structure or other subsets or supersets, which are exemplified below.

An operating system 551 includes system programs for processing various system services and performing hardware-related tasks, such as a framework layer, a kernel library layer, and a drive layer, and is configured to implement various services and process hardware-based tasks. A network communication module 552 is configured to reach other electronic devices via one or more (wired or wireless) network interfaces 520. The network interface 520 exemplarily includes: Bluetooth, a wireless fidelity (WiFi), universal serial bus (USB), and the like.

In some embodiments, an object recognition apparatus according to some embodiments may be implemented in a software manner. The object recognition apparatus according to some embodiments may be provided in various software embodiments, including various forms such as an application program, software, a software module, a script, or a code. FIG. 2 shows an object recognition apparatus 555 stored in the memory 550. The object recognition apparatus may be software in a form of a program and a plug-in, and include a series of modules: a first display module 5551, a second display module 5552, a third display module 5553, and a fourth display module 5554. These modules are logical and may be arbitrarily combined or further split depending on functions implemented. Functions of the modules will be described below.

In some embodiments, the apparatus according to some embodiments may be implemented in a hardware manner. For example, the apparatus according to some embodiments may be a processor in the form of a hardware decoding processor, programmed to perform the object recognition method according to some embodiments. For example, the processor in the form of the hardware decoding processor may use one or more application integrated circuits (ASIC), a DSP, a programmable logic device (PLD), a complex programmable logic device (CPLD), a field-programmable gate array (FPGA), or other electronic components.

In some embodiments, the terminal or the server may implement the object recognition method according to some embodiments by running various computer-executable instructions or computer programs. For example, the computer-executable instructions may be a microprogram-level command, machine instructions, or software instructions. The computer program may be an original program or a software module in an operating system, may be a native application (APP), for example, a program that may be installed in the operating system to run, such as an instant messaging APP or a web browser APP, or may be a mini program that can be embedded into any APP, for example a program that may be downloaded into a browser environment to run. In a word, the above computer-executable instruction may be any form of instruction, and the above computer program can be any form of application program, module, or plug-in.

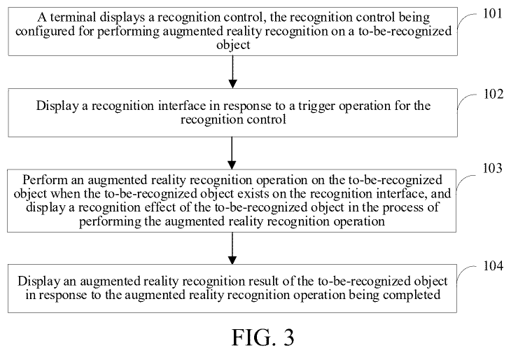

As mentioned above, the object recognition method according to some embodiments may be implemented by various types of electronic devices. For example, the method may be performed independently by the terminal in FIG. 1 or may be performed synergistically by the terminal and the server 200 in FIG. 1. An example is used for explanation, in which the terminal in FIG. 1 independently performs the object recognition method according to some embodiments. FIG. 3 is flowchart of an object recognition method according to some embodiments, which will be explained in conjunction with operations shown in FIG. 3.

Operation 101: A terminal displays a recognition control for performing augmented reality recognition on a to-be-recognized object.

Herein, during actual application, a client having an augmented reality recognition function (for example an AR recognition function) is installed in the terminal, such as a search client or an instant messaging client having the AR recognition function. A client with a mini program having the AR recognition function is installed in the terminal. For example, the instant messaging client is installed in the terminal, and the mini program having the AR recognition function is interpolated into the instant messaging client, such as a scenic region guidance mini program. When a user opens the client or the mini program having the AR recognition function, the recognition control for performing the AR recognition may be displayed, and the AR recognition may be performed on the to-be-recognized object through the recognition control.

Operation 102: Display a recognition interface in response to a trigger operation for the recognition control.

In actual application, when a user triggers the recognition control, the terminal displays, in response to the trigger operation, the recognition interface for recognizing the to-be-recognized object. An acquired image corresponding to the to-be-recognized object may be acquired through the recognition interface (for example, an acquired image that includes the to-be-recognized object is acquired), and the AR recognition is performed on the to-be-recognized object in the acquired image.

Herein, in actual application, the trigger operation may be a tap operation, a double-tap operation, a swipe operation, or an operation in another form. Some embodiments does not impose a limitation on a form of the trigger operation.

Operation 103: Perform an augmented reality recognition operation on the to-be-recognized object when the to-be-recognized object exists on the recognition interface, and display a recognition effect of the to-be-recognized object in the process of performing the augmented reality recognition operation.

In some embodiments, the terminal may display the recognition effect of the corresponding to-be-recognized object in the following mode: displaying a region in the to-be-recognized object in a target display mode, and using the used target display mode as the recognition effect of the to-be-recognized object, the target display mode being configured for indicating that augmented reality recognition is being performed on the region, and the target display mode including at least one of the following display modes: displaying the region in a preset color, displaying the region by superimposing a mask, highlighting the region, displaying the region in an outlining mode, and dynamically displaying the region.

Herein, when the to-be-recognized object exists on the recognition interface, the terminal may acquire the acquired image that includes the to-be-recognized object through an image recognition device (for example, a camera, a Webcam, or a sensor having an image acquisition function and an image recognition function), perform the AR recognition on the to-be-recognized object in the acquired image (for example, extract the to-be-recognized object in the acquired image, and match the extracted to-be-recognized object with a reference to-be-recognized object that is stored in an AR recognition library in advance (which stores a plurality of reference to-be-recognized objects associated with an AR recognition result) (for example, calculate a similarity value between an object feature of the to-be-recognized object and an object feature of the reference to-be-recognized object)), and display, in the AR recognition process, a corresponding recognition effect for a region of the to-be-recognized object, on which AR recognition is being performed (for example, the AR recognition operation or a scanning operation is being performed). The recognition effect is configured for prompting a recognition progress of the to-be-recognized object. For example, the region of the to-be-recognized object, on which the AR recognition is being performed, is displayed in a target display style, to distinguish another region (for example, a region on which no AR recognition is performed) of the to-be-recognized object except the region.

For example, the region is displayed in a preset color (for example, blue), and the another region is displayed in another color (for example, gray) that is different from the preset color. A mask is superimposed on a region, and no mask is superimposed on another region. The region is highlighted, and the another region is displayed in grayscale. The region is displayed in an outlining mode, and the another region is displayed in a (non-outlining) mode. The region may be dynamically displayed, and the another region may be statically displayed. In actual application, to further enrich the display style in the recognition process, the display style may be further extended according to an object attribute (the object attribute is configured for representing a type of the to-be-recognized object. For example, the to-be-recognized object may be one of a scenic region guidance board, an animal, a human, a plant, and the like) of the to-be-recognized object with reference to two or more target display styles, to obtain richer display styles to display the region. For example, the region is displayed in a blue and gradient outlined display style, and the another region is displayed in a display style (for example, black and non-outlined).

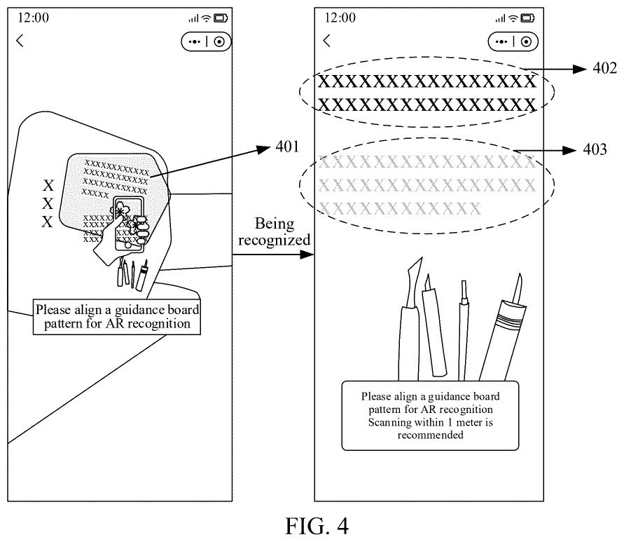

FIG. 4 is a schematic diagram of displaying of a recognition effect according to some embodiments. An example is used, in which a to-be-recognized object is text. When a to-be-recognized object 401 is located on a recognition interface, in a process of performing an AR recognition operation on the to-be-recognized object 401, a portion of text (for example a region) 402 of the to-be-recognized object, on which the AR recognition operation is being performed, is displayed by using a blue gradient outlined font, and a remaining portion of text (for example another region) 403 of the to-be-recognized object, on which no AR recognition operation is being currently performed, is displayed by using a gray non-outlined font, to highlight a recognition progress of the AR recognition currently performed on the to-be-recognized object.

In some embodiments, when the to-be-recognized object exists in the recognition interface, the terminal may perform the augmented reality recognition operation on the to-be-recognized object in the following modes: displaying, on the recognition interface, an effective recognition range and a recognition baseline within the effective recognition range; and performing the augmented reality recognition operation on the to-be-recognized object when all regions in the to-be-recognized object are located within the effective recognition range. Correspondingly, the terminal may display, in the following mode, the recognition effect of the to-be-recognized object in the process of performing the augmented reality recognition operation: controlling, in the process of performing the augmented reality recognition operation, the recognition baseline to move on the to-be-recognized object; and displaying recognition effects respectively corresponding to sub-regions in the to-be-recognized object along with the movement of the recognition baseline, the sub-regions being divided according to distances between the sub-regions and the recognition baseline.

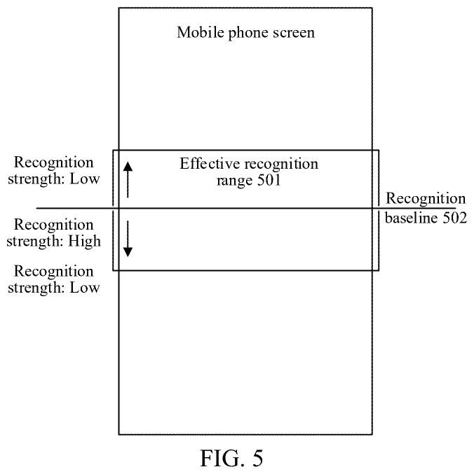

FIG. 5 is a schematic diagram of displaying of a recognition interface according to some embodiments. An effective recognition range 501 and a recognition baseline 502 are displayed on the recognition interface (for example, a mobile phone screen). When all regions of a to-be-recognized object are located within the effective recognition range, an AR recognition operation is performed on the entire to-be-recognized object, and in the process of performing the AR recognition operation, the recognition baseline 502 is controlled to move within the effective recognition range 501, thereby achieving a visual effect of controlling the recognition baseline to move on the to-be-recognized object. In the process of controlling the recognition baseline to move, the to-be-recognized object (or the acquired image) may be divided into a plurality of sub-regions in real time according to distances between pixel points in an acquired image that includes the to-be-recognized object and the recognition baseline, and recognition effects respectively corresponding to the sub-regions of the to-be-recognized object are displayed.

In some embodiments, the terminal may display the recognition effects respectively corresponding to the sub-regions of the to-be-recognized object in the following modes: displaying the recognition effects respectively corresponding to the sub-regions in the to-be-recognized object by using different display styles. different display styles being configured for indicating different sub-regions have different recognition strengths, and the recognition strength of each sub-region being in a negative correlation with the distance between the sub-region and the recognition baseline.

Herein, before the displaying recognition effects respectively corresponding to the sub-region, recognition strengths of the sub-regions are first determined. A recognition strength depends on an absolute distance between a currently recognized sub-region and the recognition baseline. The recognition strengths respectively corresponding to the sub-regions are determined according to the absolute distances between the sub-regions and the recognition baseline. For example, it is assumed that a position of a sub-region is y, a position of the recognition baseline is Sy, and a radius of the effective recognition range is r, recognition strength I may be fitted by using the following formula:

$$I = {( r - \vert y - {S}_{y} \vert )}^{2} * {( \frac{1}{r} )}^{2} .$$

It can be learned from the above formula that in a case that r is known, a shorter absolute distance between a sub-region and the recognition baseline reflects a higher recognition strength corresponding to the sub-region, and a longer distance between a sub-region and the recognition baseline reflects a lower recognition strength corresponding to the sub-region, as shown in FIG. 5. For the sub-regions, the recognition effects of the corresponding sub-regions are displayed in display styles corresponding to the recognition strengths.

For example, when the recognition effects are displayed in an outline style, a sub-region that is closer to the recognition baseline corresponds to a higher recognition strength, and a corresponding superimposing and outlining strength is higher. The superimposing and outlining strengths corresponding to the sub-regions that have distances to the recognition baseline from small to large sequentially decrease until the superimposing and outlining strengths disappear (for example, no superimposing and outlining are performed). For another example, when the recognition effects are displayed in an animation style, a sub-region that is closer to the recognition baseline corresponds to a higher recognition strength, and a corresponding action strength is higher. The action strengths corresponding to the sub-regions that have distances to the recognition baseline from small to large sequentially decrease until the action strength disappears (for example, the recognition baseline stands still). An animation effect is achieved, in which the recognition effect gradually disappears in the recognition process.

In some embodiments, the terminal may control, in the following mode, the recognition baseline to move on the to-be-recognized object: obtaining a time displacement function, the time displacement function being configured for controlling the recognition baseline to move, and controlling, according to the time displacement function, the recognition baseline to move on the to-be-recognized object, the recognition baseline located at a first position in the to-be-recognized object being configured for indicating that augmented reality recognition is being performed on a sub-region in which the first position in the to-be-recognized object is. Correspondingly, the terminal may display the recognition effects respectively corresponding to the sub-regions of the to-be-recognized object in the following modes: determining a second position of the recognition baseline on the to-be-recognized object according to the time displacement function in the process of controlling the recognition baseline to move on the to-be-recognized object; and performing effect rendering on a sub-region in which the second position is, to obtain a effect rendering result, and displaying the effect rendering result as a recognition effect of the sub-region in which the second position is.

In actual application, when performing the augmented reality recognition operation on the to-be-recognized object through an image recognition device (for example, a camera), the terminal may use a fragment shader in the image recognition device (for example, the camera) to perform the effect rendering on the sub-regions of the to-be-recognized object. For example, the time displacement function is added into the fragment shader, to control, through the time displacement function, the position of the recognition baseline to change over time and inform the fragment shader of which sub-regions effect rendering may be performed on at a current moment. The recognition baseline is configured for indicating the recognition progress. For example, the recognition baseline located at the second position in the to-be-recognized object is configured for indicating that the AR recognition is being performed on the sub-region corresponding to the second position. In the process of controlling the recognition baseline to move, a real-time position (for example, the above second position) of the recognition baseline on the to-be-recognized object is determined in real time according to the time displacement function, and the effect rendering is performed through the fragment shader on the sub-region in which the real-time position of the recognition baseline is, and the effect rendering is not performed on a sub-region in which another position except the real-time position is.

When the effect rendering is performed on the sub-region in which the second position (for example the real-time position of the recognition baseline on the to-be-recognized object) is, the fragment shader may add a effect element (for example a effect rendering result) to the sub-region in which the second position is, and superimpose the effect element with the acquired image (for example the acquired image that includes the to-be-recognized object) to obtain a superimposed image, so that the superimposed image is used as a camera image displayed by the terminal in the AR recognition process. The recognition effect of the sub-region with the second position is a effect element in the superimposed image.

In some embodiments, an augmented reality recognition operation is performed on partial regions in the to-be-recognized object when the partial regions in the to-be-recognized object are located within the effective recognition range; and in the process of performing the augmented reality recognition operation, displaying the recognition effects of the partial regions and displaying original content of another region in the to-be-recognized object except the partial regions, where the recognition effects include original content and effect elements of the partial regions.

Herein, when partial regions in the to-be-recognized object are located within the effective recognition range and partial regions are located beyond the effective recognition range, in the process of performing the augmented reality recognition operation, the effect rendering is performed on the partial regions of the to-be-recognized object that are located within the effective recognition range. For example, the fragment shader adds a effect element to the original content of the partial regions located within the effective recognition range, uses the original content of the partial regions located within the effective recognition range and the added effect element together as the recognition effects of the partial regions located within the effective recognition range, and displays the recognition effects. The effect rendering is not performed on another region of the to-be-recognized object that is located beyond the effective recognition range (for example, no effect element is added), and original content of the another region located beyond the effective recognition range is maintained unchanged. Through the above method, the recognition progress of the current AR recognition can be quickly determined according to the displayed recognition effect, thereby not only enriching the display styles of the recognition process and improving the interestingness of an interaction process, but also improving the utilization rate of a graphic processing resource in the terminal, enabling a user to intuitively perceive the AR recognition progress, and enhancing the user experience of AR recognition.

In some embodiments, the terminal may display the recognition effect of the to-be-recognized object in the following mode: performing image edge extraction on an acquired image that includes the to-be-recognized object, to obtain an edge image; and superimposing the edge image with the acquired image, to obtain an outlined image, and displaying the outlined image as the recognition effect of the to-be-recognized object.

Herein, when the recognition effect is displayed in the outline style, in the AR recognition process, image edge processing is performed on the acquired image directly through the image recognition device (for example, the fragment shader in the image recognition device). For example, an image edge extraction operation is performed on the acquired image by using an edge extraction algorithm in the fragment shader, to obtain a horizontal edge image and a vertical edge image of the acquired image, and the horizontal edge image is combined with the vertical edge image, to obtain the edge image of the acquired image. The edge image is superimposed with the acquired image to obtain the outlined image, and the outlined image is displayed as the recognition effect of the to-be-recognized object. For example, the outlined image is configured for indicating that the AR recognition is being performed on the to-be-recognized object. This not only enriches displayed content of the recognition process and improving the interestingness of an interaction process, but also improves the utilization rate of a graphic processing resource in the terminal, enables a user to intuitively perceive the AR recognition process, and enhancing the user experience of AR recognition.

In some embodiments, the terminal may superimpose the edge image with the acquired image in the following mode, to obtain the outlined image: obtaining a color value for changing a color of the edge image, and multiplying the color value by the edge image, to obtain an edge image with a preset color; and superimposing the edge image with the preset color and the acquired image, to obtain an outlined image with a target color, and displaying the outlined image with the target color as the recognition effect of the to-be-recognized object.

Herein, after the edge image is extracted from the acquired image, the color value for changing the color of the edge image may be set, and the color value is multiplied by the edge image, to obtain the edge image with the preset color, to change the color of the edge image. Considering that the fragment shader may be configured to fill a color of each pixel point in the image, the color of the edge image may be adjusted and set in the fragment shader. For example, the color value of the extracted edge image is multiplied in the fragment shader by the color value (which may be set according to an actual need) for changing the color of the edge image, to obtain the edge image with the preset color (for example, the color of the edge image is adjusted and set to the preset color from the color before the adjustment and setting). After the edge image is set to have the preset color, the edge image with the preset color is superimposed with the original acquired image, to obtain the outlined image with the target color, and the outlined image with the target color is displayed as the recognition effect of the to-be-recognized object. By customizing edge images with various colors, an outlined image with a desired target color can be conveniently obtained. A user can control a effect display form in an entire AR process, thereby improving the convenience and enhancing the controllable recognition experience.

Herein, the preset color may be the same as or different from the target color. When the acquired image is a grayscale image, the target color is the same as the preset color. When the acquired image is a colored image, the target color is obtained by superimposing and blending the preset color with the color of the acquired image. The target color may be different from the preset color.

In some embodiments, the terminal may display the recognition effect of the to-be-recognized object in the following mode: performing texture extraction on an acquired image that includes the to-be-recognized object, to obtain an image texture of the acquired image; obtaining an animation texture having a ripple density change, and fusing the animation texture with the image texture, to obtain a ripple image having the ripple density change; and displaying the ripple image having the ripple density change as the recognition effect of the to-be-recognized object.

The changed ripple density is configured for indicating a recognition progress of the augmented reality recognition operation. For example, before the AR recognition, a ripple density is 0 (or it may be considered that there is no ripple). As the AR recognition is performed, the ripple density increases from 0. A larger ripple density (for example denser ripples) indicates that the AR recognition progress is about to be completed.

In actual application, the texture extraction may be performed, through the fragment shader in the image recognition device, on the acquired image that includes the to-be-recognized object, to obtain the image texture of the acquired image. The animation texture having the ripple density change is obtained. The animation texture and the image texture are fused to obtain the ripple image having the ripple density change, and the ripple image having the ripple density change is used as the recognition effect of the to-be-recognized object.

In the recognition process, by displaying the recognition effect of the ripple image having the ripple density change, displayed content in the recognition process is enriched, and it is convenient for a user to quickly know the recognition progress, thereby improving the user experience of AR recognition.

In some embodiments, the terminal may display the recognition effect of the to-be-recognized object in the following mode: obtaining a ripple diffusion function, the ripple diffusion function being configured for indicating that a ripple diffusion range changes over time; obtaining a ripple element, the ripple element performing fluctuating diffusion from a ripple diffusion center to a periphery according to the ripple diffusion function; and fusing an acquired image that includes the to-be-recognized object with the ripple element, to obtain a ripple image having a ripple diffusion range change, and using the ripple image having the ripple diffusion range change as the recognition effect of the to-be-recognized object, where a changing ripple diffusion range is configured for indicating a recognition progress of the augmented reality recognition operation.

Herein, the ripple diffusion function is configured for indicating that the ripple diffusion range changes over time. The ripple diffusion range may be considered as that a radius of a circle continuously increases over time. In the process of performing the AR recognition on the to-be-recognized object, the changing ripple diffusion range is configured for indicating the AR recognition progress. For example, when a center of the acquired image that includes the to-be-recognized object is used as the ripple diffusion center, the ripple diffusion range may be considered as the ripple element that performs the fluctuating diffusion from the ripple diffusion center to the periphery according to the ripple diffusion function, for example, a ripple element that diffuses from the ripple diffusion center to the periphery in a circular ring mode. The ripple element may be configured for indicating that the AR recognition is sequentially performed from the center to the periphery of the acquired image. For example, an image region of the acquired image, on which the AR recognition is being performed, displays a corresponding recognition effect. The recognition effect is the ripple image obtained by fusing and superimposing original content of the image region with a corresponding ripple element.

In actual application, the ripple diffusion function may be added to the fragment shader in the image recognition device, to obtain, through the fragment shader, the ripple element that performs the fluctuating diffusion according to the ripple diffusion function, and the ripple element is fused with the acquired image that includes the to-be-recognized object, to obtain the ripple image having the ripple diffusion range change.

In the recognition process, by displaying the recognition effect of the ripple image having the ripple diffusion range change, displayed content in the recognition process is enriched, and it is convenient for a user to quickly know the recognition progress, thereby improving the user experience of AR recognition.

In some embodiments, the terminal may obtain the ripple element in the following mode: determining an offset parameter according to the ripple diffusion function, the offset parameter being configured for affecting a coordinate offset of each pixel point in the acquired image; obtaining a pixel coordinate offset function, the pixel coordinate offset function being configured for dynamically changing the coordinate offset of each pixel point in the acquired image; determining final coordinates of each pixel point according to original coordinates of each pixel point, the offset parameter, and the pixel coordinate offset function; and performing ripple effect rendering according to the final coordinates of each pixel point and the ripple diffusion function, to obtain the ripple element.

Herein, since a maximum range of ripple diffusion may be determined according to the ripple diffusion function, and a maximum value of the coordinate offset of each pixel point does not exceed the maximum range of the ripple diffusion, the coordinate offset of each pixel point may be limited within a particular range through the ripple diffusion function. During the calculation of the offset parameter corresponding to each pixel point, a corresponding offset parameter may be obtained by using a clamp (MIN, VAL, MAX) function, where MIN (a minimum value) and MAX (a maximum value) may be set artificially. MAX may be set to be the maximum range of ripple diffusion, and VAL may be the coordinate offset of the pixel point. The clamp (MIN, VAL, MAX) function is to limit VAL to be between a minimum value (MIN, which may be set, for example, to 0) and a maximum value (MAX, which may be set, for example, to 5). When VAL is less than MIN, the coordinate offset of the pixel point is set to MIN. When VAL is between the minimum value and the maximum value, the coordinate offset of the pixel point is set to VAL. When VAL is greater than MAX, the coordinate offset of the pixel point is set to MAX.

Some embodiments principle of a visual effect of the ripple image having the ripple diffusion range change is similar to stretching each pixel point in the acquired image around the ripple diffusion center. The pixel coordinate offset function is configured for dynamically changing the coordinate offset of each pixel point in the acquired image. The pixel coordinate offset function may be represented by a sine function changing over time. For example, the coordinate offset of each pixel point may be dynamically changed through the pixel coordinate offset function, so that a stretching strength of a current image is periodically changed over time.

Final coordinates of each pixel point may be determined according to the original coordinates, the offset parameter, and the pixel coordinate offset function of each pixel point, and then ripple effect rendering is performed according to the final coordinates of each pixel point and the ripple diffusion function, to obtain the ripple element.

In some embodiments, the terminal may determine the final coordinates of each pixel point according to the original coordinates of each pixel point, the offset parameter, and the pixel coordinate offset function in the following mode: multiplying, when the ripple diffusion center is a center position of the acquired image, the original coordinates of each pixel point, the offset parameter, and the pixel coordinate offset function, to obtain the final coordinates of each pixel point; and when the ripple diffusion center is another position on the recognition interface except the center position of the acquired image, obtaining coordinate differences between the original coordinates of each pixel point and the ripple diffusion center, and multiplying the coordinate differences of each pixel point, the offset parameter, and the pixel coordinate offset function, to obtain the final coordinates of each pixel point.

Herein, when the ripple diffusion center is the center position of the acquired image (for example, the ripple diffusion center overlaps the center of the acquired image), the following processing is performed for each pixel point in the acquired image: multiplying the original coordinates of the pixel point, the offset parameter, and the pixel coordinate offset function, to obtain the final coordinates of the pixel point (for example, a multiplication result of the original coordinates of the pixel point, the offset parameter, and the pixel coordinate offset function is used as the final coordinates of the pixel point); and after final coordinates of all pixel points in the acquired image are obtained, then performing the ripple effect rendering according to the final coordinates of all the pixel points in the acquired image and the ripple diffusion function, to obtain the ripple element of the acquired image. When the ripple diffusion center is another position on the recognition interface except the center position of the acquired image (for example, the ripple diffusion center overlaps the center of the acquired image), the following processing is performed for each pixel point in the acquired image: calculating coordinate differences between the original coordinates of the pixel point and the ripple diffusion center, then multiplying the calculated coordinate differences, the offset parameter, and the pixel coordinate offset function, to obtain the final coordinates of the pixel point (for example, multiplication results of the coordinate differences corresponding to the pixel point, the offset parameter, and the pixel coordinate offset function is used as the final coordinates of the pixel point); and after final coordinates of all pixel points in the acquired image are obtained, then performing the ripple effect rendering according to the final coordinates of each pixel point and the ripple diffusion function, to obtain the ripple element of the acquired image.

In some embodiments, the terminal may perform an augmented reality recognition operation on the to-be-recognized object and display a recognition effect of the to-be-recognized object in the process of performing the augmented reality recognition operation in the following mode: performing the augmented reality recognition operation on the to-be-recognized objects when at least two to-be-recognized objects exist on the recognition interface, and displaying recognition effects of the to-be-recognized objects by using different display styles in the process of performing the augmented reality recognition operation. Correspondingly, the terminal may display an augmented reality recognition result of the to-be-recognized object in the following mode: respectively displaying augmented reality recognition results of the to-be-recognized objects.

Herein, when a plurality of to-be-recognized objects, for example, to-be-recognized object 1 and to-be-recognized object 2, exist on the recognition interface, an augmented reality recognition operation may be automatically performed on the to-be-recognized objects respectively. For example, AR recognition is performed on to-be-recognized object 1, and AR recognition is performed on to-be-recognized object 1. In the process of performing the augmented reality recognition operations, recognition effects of different to-be-recognized objects are displayed by using different display styles. For example, when a plurality of different to-be-recognized objects exist on the recognition interface, display styles of the recognition effects corresponding to the different to-be-recognized objects are different. For example, recognition effect 1 of to-be-recognized object 1 is displayed in display mode 1, and recognition effect 2 of to-be-recognized object 2 is displayed in display mode 2 (that is different from display mode 1). Augmented reality recognition results respectively corresponding to the to-be-recognized objects are displayed when the AR recognition is completed. For example, augmented reality recognition result 1 of to-be-recognized object 1 and augmented reality recognition result 2 of to-be-recognized object 2 are respectively displayed. The AR recognition is performed on the plurality of to-be-recognized objects on the recognition interface, and the recognition effects and recognition results of the plurality of to-be-recognized objects are displayed on the same recognition interface. This can meet increasingly diversified information obtaining requirements of users while improving the efficiency of recognizing the to-be-recognized objects, so that the recognition effects and the recognition results that are displayed on the recognition interface are more diversified, thereby improving the utilization rate of a graphic processing resource in the terminal.

During the AR recognition on the plurality of to-be-recognized objects, AR recognition operations for different to-be-recognized objects may be performed in series or in parallel. The disclosure does not limit a sequence of performing the AR recognition operations on different to-be-recognized objects.

In some embodiments, the terminal may perform an augmented reality recognition operation on the to-be-recognized object and display a recognition effect of the to-be-recognized object in the process of performing the augmented reality recognition operation in the following mode: controlling, when at least two to-be-recognized objects exist on the recognition interface, the at least two to-be-recognized objects to be in a selectable state; and performing the augmented reality recognition operation on the target to-be-recognized object in response to a selection operation for a target to-be-recognized object, and displaying a recognition effect of the target to-be-recognized object in the process of performing the augmented reality recognition operation. Correspondingly, the terminal may display an augmented reality recognition result of the to-be-recognized object in the following mode: displaying an augmented reality recognition result of the target to-be-recognized object.

Herein, when a plurality of to-be-recognized objects exist on the recognition interface, for example, to-be-recognized object 1 and to-be-recognized object 2, the terminal may control each to-be-recognized object to be in the selectable state, and a user may select the target to-be-recognized object (e.g. to-be-recognized object 1) therefrom for AR recognition. The terminal may display the recognition effect of the selected target to-be-recognized object in the process of performing the AR recognition on the target to-be-recognized object, and display the augmented reality recognition result of the selected target to-be-recognized object (for example, to-be-recognized object 1) after completing the AR recognition operation on the target to-be-recognized object. The user may conveniently select a desired to-be-recognized object, thereby improving the pertinence of AR recognition.

In actual application, when a plurality of different to-be-recognized objects (for example, to-be-recognized object 1 or to-be-recognized object 2) exist on the recognition interface, different to-be-recognized objects have different recognition priorities. For ease of distinguishing, the to-be-recognized objects may be displayed by using different display styles according to the recognition priorities of the to-be-recognized objects. For example, if the recognition priority of to-be-recognized object 1 is higher than the recognition priority of to-be-recognized object 2. To-be-recognized object 1 is displayed by using a first display style, and to-be-recognized object 2 is displayed by using a second display style. The first display style is different from the second display style. For example, they are different fonts, different text colors, different display backgrounds, different text transparencies, or the like, to highlight to-be-recognized object 1 and distinguish to-be-recognized object 1 from to-be-recognized object 2, to provide a conspicuous prompt to a user, so that the user quickly selects a to-be-recognized object with a high recognition priority for AR recognition, thereby improving the recognition efficiency.

In some embodiments, the terminal may perform an augmented reality recognition operation on the to-be-recognized object and display a recognition effect of the to-be-recognized object in the process of performing the augmented reality recognition operation in the following mode: performing the augmented reality recognition operation on a target to-be-recognized object when at least two to-be-recognized objects exist on the recognition interface, and displaying a recognition effect of the target to-be-recognized object in the process of performing the augmented reality recognition operation, where a recognition priority of the target to-be-recognized object is higher than a recognition priority of another to-be-recognized object; and Correspondingly, the terminal may perform an augmented reality recognition operation on the to-be-recognized object and display a recognition effect of the to-be-recognized object in the process of performing the augmented reality recognition operation in the following mode: displaying an augmented reality recognition result of the target to-be-recognized object.

The another to-be-recognized object is a to-be-recognized object in the at least two to-be-recognized objects except the target to-be-recognized object.

Herein, when a plurality of to-be-recognized objects exists on the recognition interface, for example, to-be-recognized object 1 and to-be-recognized object 2, different to-be-recognized objects have different recognition priorities. For example, it is assumed that the recognition priority of to-be-recognized object 1 is higher than the recognition priority of to-be-recognized object 2. The terminal automatically selects the target to-be-recognized object (for example, to-be-recognized object 1) having the highest recognition priority from among the plurality of to-be-recognized objects for AR recognition, displays the recognition effect of the target to-be-recognized object (for example, to-be-recognized object 1) in the process of performing the AR recognition on the target to-be-recognized object, and displays the augmented reality recognition result of the target to-be-recognized object (for example, to-be-recognized object 1) after completing the AR recognition operation on the target to-be-recognized object. The terminal can automatically perform the AR recognition on the to-be-recognized object having the highest recognition priority, thereby improving the intelligence and pertinence of AR recognition.

In some embodiments, the terminal may determine the recognition priority of the target to-be-recognized object through the following processing: determining an impact parameter for affecting the recognition priority of the target to-be-recognized object, the impact parameter including at least one of the following: a position of the target to-be-recognized object on the recognition interface, an object type to which the target to-be-recognized object belongs, a historical interaction popularity of the target to-be-recognized object, and a degree of matching between the target to-be-recognized object and a current user; and invoking a neural network model for prediction based on the impact parameter, to obtain the recognition priority of the target to-be-recognized object, the neural network model being obtained by training on an impact parameter for affecting a recognition priority of a to-be-recognized object sample and a marked recognition priority of the to-be-recognized object sample.

Different positions of the target to-be-recognized object on the recognition interface have different impacts on the recognition priority of the target to-be-recognized object. For example, compared with an edge position, a middle position of recognition interface has a greater positive influence on the recognition priority of the target to-be-recognized object (for example, the recognition priority of the to-be-recognized object located at the middle location of the recognition interface is higher than the recognition priority of the to-be-recognized object located at the edge location of the recognition interface). The object type to which the target to-be-recognized object belongs is a species category corresponding to the target to-be-recognized object, including but not limited to: animal, plant, human, text, display board, and the like. Different object types may correspond to different recognition priorities. A historical interaction popularity of the target to-be-recognized object is influenced by historical access data, historical AR recognition data, historical interaction data, and the like. A larger amount of historical access data, historical AR recognition data, historical interaction data, and the like indicates a higher historical interaction popularity, and the corresponding target to-be-recognized object has a higher recognition priority. A degree of matching between the target to-be-recognized object and a current user (for example, a user on a terminal side) means a degree of matching between an object feature (e.g., an object type feature) of the target to-be-recognized object and a feature (e.g., the interest, the education, or the native place) of the user (e.g., a similarity between the object feature and the feature of the user). A higher degree of matching between the target to-be-recognized object and the current user indicates a higher recognition priority of the target to-be-recognized object. After the impact parameter that affects the recognition priority of the target to be recognized is obtained, the impact parameter is input to the trained neural network model for prediction, to obtain the recognition priority of the target to be recognized, so that the prediction can be more accurate. For each to-be-recognized object, the corresponding recognition priority may be predicted by using the above method.

By the above method, the impact parameter of each to-be-recognized object on the recognition interface may be obtained, and the recognition priority of each to-be-recognized object is predicted based on the impact parameter. When the impact parameter includes the degree of matching between the to-be-recognized object and the current user, since different users correspond to different features, the degrees of matching between different users and the same to-be-recognized object are usually different. For example, the same to-be-recognized object has different recognition priorities for different users. When a plurality of to-be-recognized objects exist on the recognition interface, for AR recognition requests of different users, terminals of the users all automatically perform AR recognition on to-be-recognized objects having highest recognition priorities. For different users, the to-be-recognized objects that are recognized are different even in face of a plurality of identical to-be-recognized objects. For example, to-be-recognized object 1, to-be-recognized object 2, and to-be-recognized object 3 exist in the same scenic region guidance board. For user A, to-be-recognized object 1 has the highest recognition priority. For user B, to-be-recognized object 3 has the highest recognition priority. When a terminal of user A scans the scenic region guidance board, the terminal automatically performs AR recognition on to-be-recognized object 1 in the guidance board, and displays a recognition effect of to-be-recognized object 1 in the AR recognition process. When a terminal of user B scans the scenic region guidance board, the terminal automatically performs AR recognition on to-be-recognized object 3 in the guidance board, and displays a recognition effect of to-be-recognized object 3 in the AR recognition process. The intelligence and pertinence of recognition are greatly improved.

Herein, before the neural network model is applied, an initial neural network model may be trained, and the trained neural network model is put into application, to predict the recognition priority of the target to-be-recognized object through an artificial intelligence technology in combination with an interaction of a user with the target to-be-recognized object. The neural network model is obtained by training on the impact parameter on the recognition priority of the to-be-recognized object sample and the marked recognition priority of the to-be-recognized object sample. For example, the initial neural network model is invoked for prediction based on the historical interaction popularity of the to-be-recognized object sample and the marked recognition priority of the to-be-recognized object sample, to obtain a predicted recognition priority. After a value of a loss function of the neural network model is determined through the predicted recognition priority and the marked recognition priority, whether the value of the loss function exceeds a preset threshold may be determined. When the value of the loss function exceeds the preset threshold, an error signal of the neural network model is determined based on the loss function, and the error signal is back-propagated in the neural network model; and a model parameter of each layer is updated in the propagation process. A model structure of the neural network model is not limited in some embodiments. For example, the neural network model may be a convolutional neural network, a deep neural network, or the like. A form of the loss function is not limited either. For example, the loss function may be a cross entropy loss function, an L2 loss function, or the like.

The back-propagation is described herein. Training sample data is input to an input layer of the neural network model. The data passes through a hidden layer and finally reaches an output layer, and a result is output. This is a forward-propagation process of the neural network model. Since there is an error between an output result of the neural network model and an actual result, an error between the output result and an actual value is calculated, and the error is back-propagated from the output layer to the hidden layer until the error is propagated to the input layer. In the back-propagation process, a value of the model parameter is adjusted based on the error. For example, the loss function is constructed according to the error between the output result and the actual value, and partial derivatives of the loss function for the model parameter are calculated layer by layer, to generate a gradient of the loss function for the model parameter of each layer. Since a direction of the gradient indicates an error expansion direction, the gradient for the model parameter is negated for summation with an original model parameter of each layer. An obtained summation result is used as an updated model parameter of each layer, thus reducing the error caused by the model parameter. The foregoing process is continuously iterated until convergence is achieved.

In some embodiments, in the process of displaying the recognition effect of the to-be-recognized object, the terminal may further display recognition progress indication information by using a target mode. The target mode includes at least one of the following: a progress bar, a percentage, and countdown, where the recognition progress indication information is configured for indicating a recognition progress of the augmented reality recognition operation.

In actual application, the recognition progress and recognition effect of the to-be-recognized object may be separately displayed. For example, the recognition progress indication information is displayed by using the target mode when the recognition effect is displayed, to indicate the recognition progress of the current AR recognition (for example, a completion degree of the AR recognition). For example, the recognition progress indication information is displayed through a progress bar. The more the progress bar is filled, the higher completion degree the current AR recognition has. The progress bar is completely filled, it indicates that the current AR recognition has been completed. For another example, the recognition progress indication information is displayed through a percentage. A larger percentage indicates a higher completion degree of the current AR recognition. When the percentage is 100%, it indicates that the current AR recognition has been completed. For another example, the recognition progress indication information is displayed through countdown. The countdown closer to zero indicates a higher completion degree of the current AR recognition. When the countdown is zero, it indicates that the current AR recognition has been completed. The recognition effect and the recognition progress are displayed on the same recognition interface at the same time, so that content displayed on the recognition interface is more diversified, which meets increasingly diversified information obtaining requirements of a user and improving the utilization rate of a graphic processing resource in the terminal.

Operation 104: Display an augmented reality recognition result of the to-be-recognized object in response to the augmented reality recognition operation being completed.

Herein, when the augmented reality recognition operation performed on the to-be-recognized object is completed, the corresponding augmented reality recognition result is displayed. When the AR recognition on the to-be-recognized object succeeds, an augmented reality recognition result for indicating successful AR recognition, such as the augmented reality recognition result (for example, an AR recognition result) of the to-be-recognized object, is directly displayed. There are various forms of the augmented reality recognition result. For example, the augmented reality recognition result may be an AR recognition model (for example, a three-dimensional model of the to-be-recognized object), or may be an AR recognition video (for example, a video image for introducing the to-be-recognized object). The augmented reality recognition result may be in another form. The form of the augmented reality recognition result is not limited in some embodiments.

In some embodiments, the terminal may display an augmented reality recognition result of the to-be-recognized object in the following mode: displaying an augmented reality recognition result of another to-be-recognized object; or displaying recommendation guidance information, the recommendation guidance information being configured for guiding to view an augmented reality recognition result of another to-be-recognized object; and using the augmented reality recognition result of the another to-be-recognized object or the recommendation guidance information as the augmented reality recognition result of the to-be-recognized object, where a correlation between the another to-be-recognized object and the to-be-recognized object is greater than a correlation threshold.

In actual application, when the AR recognition on the to-be-recognized object fails (for example, no AR recognition result information about the to-be-recognized object is recognized), an AR recognition result of another to-be-recognized object related to the to-be-recognized object may be recommended, and the AR recognition result of the another to-be-recognized object is used as the AR recognition result of the to-be-recognized object. For example, an example is used, in which the augmented reality recognition result is an AR mode. When the AR model of the to-be-recognized object is successfully recognized, the recognized AR model is displayed as the augmented reality recognition result of the to-be-recognized object. When the AR model of the to-be-recognized object is not recognized, an augmented reality recognition result for indicating that the AR model corresponding to the to-be-recognized object is not recognized is displayed, or a recommended AR recognition model of the another to-be-recognized object is displayed, or recommendation indication information for instructing and recommending to view the AR model of the another to-be-recognized object is displayed. When a user triggers the recommendation indication information, the terminal may display, in response to the trigger operation, the AR model of the another to-be-recognized object for the user to view.

In actual application, when the object recognition method according to some embodiments is applied to a scenic region navigation application, if a point of interest (POI), such as a building, a statue, or a lake, in a scenic region exists on the recognition interface, an augmented reality recognition operation (for example, AR recognition) may be performed on the POI (e.g., the building), and a recognition effect corresponding to the POI is displayed in the AR recognition process, to indicate a recognition progress of the POI through the recognition effect. An AR recognition result (such as a three-dimensional model of the building or an introduction video image of the building, to introduce the building) corresponding to the POI is displayed when the AR recognition operation is completed.

The following will describe exemplary application of some embodiments in an actual application scene.

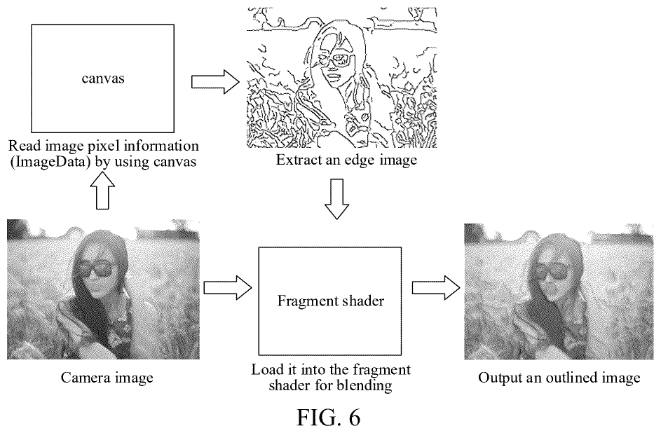

FIG. 6 is a schematic diagram of obtaining of an outlined image according to some embodiments. During scanning and recognition on a to-be-recognized object through an image recognition device (such as a camera), after the camera acquires an acquired image (for example, a camera image) that includes the to-be-recognized object, corresponding pixel information is extracted from the acquired image by using a canvas, and edge detection is performed on the acquired image according to the pixel information by using some image processing technologies (such as jsfeat) in an image database (such as a JavaScript computer vision library), to obtain an edge image of the acquired image. The edge image is loaded into a fragment shader, and the edge image and the original acquired image are superimposed (for example, blended) through the fragment shader, to obtain an outlined image of the acquired image, thereby outlining the camera image and presenting a scanning effect.

In an image outlining solution of the related art, on the one hand, a large number of computing resources may be occupied in the process of performing the edge detection by using the image processing library when the image is converted into the pixel information by using the canvas, and phenomena such as frame freezing, frame dropping, and heat may occur in a scene, such as the camera, in which an image needs high-frequency real-time rendering and high-frame-rate presenting. The accuracy of the extracted edge image is low, so that a finally presented scanning effect experience is poor.

In some embodiments, a digital image processing logic for extracting an edge is directly implemented in a fragment processor (for example, the fragment shader) of the camera. Image processing and drawing are performed on each pixel point (also referred to as a fragment) in the acquired image. Operations and a code quantity are reduced. By virtue of a high-performance image rendering capability of a web graphics library (WebGL) based on a graphics processing unit (GPU), the computational overheads are greatly reduced, phenomena such as frame freezing and frame dropping do not occur any longer, and a detected edge is more accurate, thereby providing a better image effect. By using the method of directly rewriting the fragment processor in the camera, another texture or image processing logic is added to bring a richer camera image effect.

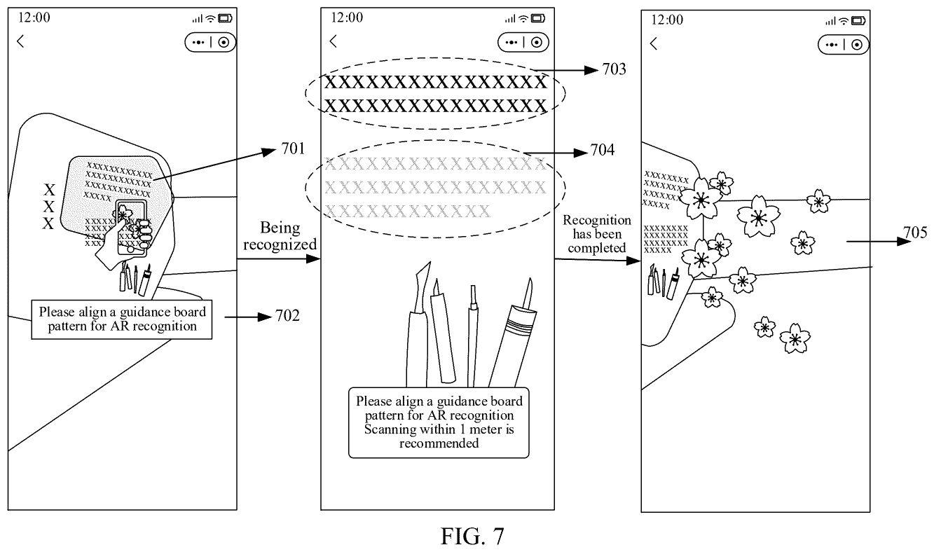

FIG. 7 is a schematic diagram of object recognition according to some embodiments. An example is used, in which a client is installed on a terminal and a mini program having an AR recognition function is embedded into the client, such as a scenic region guidance mini program. In response to a trigger operation for a recognition control, the terminal displays a recognition interface for AR recognition, and displays prompt information 702 for prompting a user to align a guidance board pattern (for example, the above to-be-recognized object) 701 on the recognition interface. When aligning the guidance board pattern 701 based on the prompt information 702, the terminal may perform an AR recognition operation on the guidance board pattern 701. In the process of performing the AR recognition operation, the terminal displays a recognition effect for the guidance board pattern 701. The recognition effect may reflect a recognition progress of performing the AR recognition on the guidance board pattern 701. For example, when a scanning animation moves to text 703 above the guidance board pattern 701, a blue gradient outlining effect (for example, the recognition effect) is displayed on the text 703, to indicate that the AR recognition is being performed on the text 703, and no recognition effect is displayed on text 704 of the guidance board pattern 701, on which no AR recognition is performed. In the recognition process, a technological effect of outlining a current camera image in real time is presented, thereby reducing a feeling of boring of a user during waiting and enhancing the user experience of participating in AR recognition interaction. After the recognition succeeds, an AR model 705 corresponding to the guidance board pattern 701 is displayed.

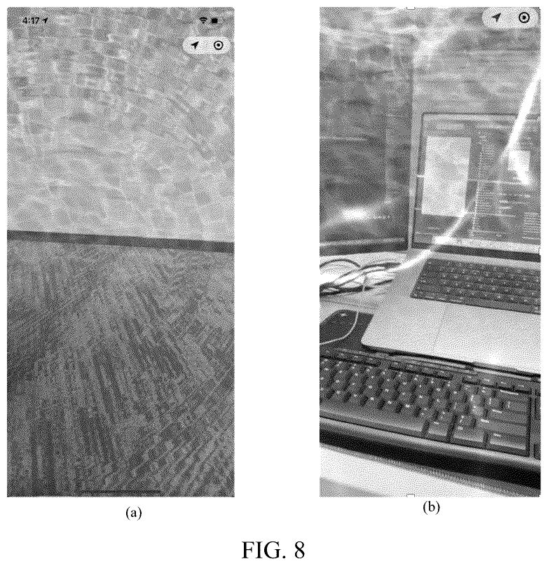

A new texture may be further featured for a fragment shader, and a new image processing logic is added to enrich camera images. FIG. 8 is a schematic diagram of displaying of a recognition effect according to some embodiments. In FIG. 8, (a) shows a water ripple fluctuation effect (a visual presentation is: water ripples diffuse and fluctuate from a fluctuation center point to the outside), and a effect of the water ripple effect is used as a recognition effect. In FIG. 8, (b) shows a glistening effect (a visual expression is: ripples on a water surface change), and a effect of the glistening effect is used as a recognition effect. By using the foregoing mode, in the AR recognition process, a visual effect that a user seems to stand on a glistening water surface to observe the world is achieved, thereby bringing a richer experience.

The following explains implementation principles of various recognition effects.

### 1. Outlining Effect

### 1.1 Image Edge Extraction

In the process of performing the AR recognition on the to-be-recognized object by the camera, the edge detection is performed, through the fragment shader in the camera, on the acquired image (for example, the current camera image) that includes the to-be-recognized object, to obtain the edge image of the acquired image. Since in the fragment shader of the camera image, color values of a fragment (for example, each pixel point in the acquired image) are generated one by one by sampling corresponding uv texture coordinates, the uv texture coordinates of the fragment are sampled in the fragment shader, and the color values of the fragment are stored.

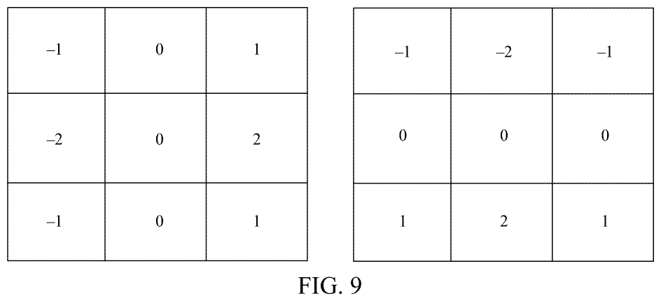

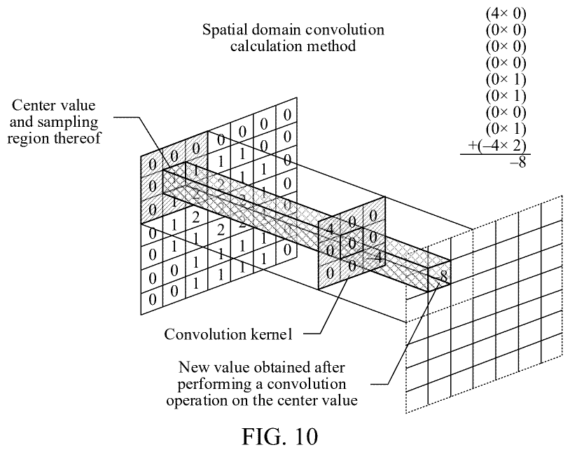

A Sober operator with a 3*3 kernel shown in FIG. 9 (FIG. 9 is a schematic diagram of a Sober operator according to some embodiments) is used as a convolution kernel template. A spatial domain convolution operation is performed on the sampled color values by using a spatial domain convolution operation method shown in FIG. 10 (FIG. 10 is a schematic diagram of a spatial domain convolution operation according to some embodiments), to obtain the edge image. Color values obtained by transforming the color values of a pixel point, located at an edge, in the acquired image are large, for example, are close to or equal to 1 (displayed as a white part in the edge image), and color values obtained by transforming the color values of a pixel point, not located at an edge, in the acquired image are small, for example, are close to or equal to 0 (displayed as a black part in the edge image). After the edge image is calculated, only the color values (for example, the color values obtained by transforming the color values of the pixel points in the acquired image) of the edge image are stored. During determination of a gradient value of each pixel point in the acquired image, a horizontal gradient value and a vertical gradient value of the pixel point are required. Pixel point I (x, y) is used as an example. Assuming that a horizontal gradient of pixel point I (x, y) is Gx and a vertical gradient of pixel point I (x, y) is Gy, a gradient strength of pixel point I (x, y) is

$$G = \sqrt{{G}_{x}^{2} + {G}_{y}^{2}} ,$$

and a direction is

$$θ = {tan}^{- 1} ( \frac{{G}_{y}}{{G}_{x}} ) .$$

After the gradient value of each pixel point in the acquired image is obtained, the obtained gradient values of the pixel points are summated, to obtain a gradient value (for example, the edge image of the acquired image) of the acquired image.

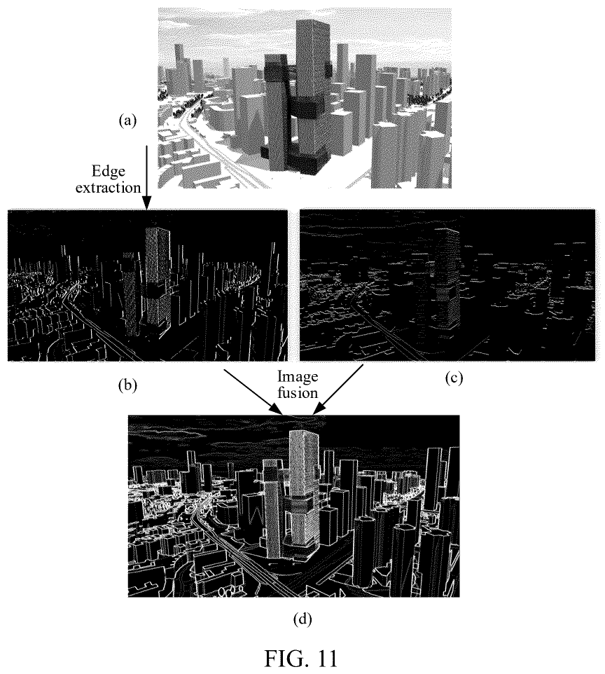

FIG. 11 is a schematic diagram of edge detection according to some embodiments. After edge detection is performed on an acquired image in (a), a horizontal edge image in (b) and a vertical edge image in (c) are obtained. The horizontal edge image in (b) and the vertical edge image in (c) are fused, to obtain a final edge image of the acquired image shown in (d).

### 1.2 Edge Color Change and Superimposition

After the edge image of the acquired image is obtained, a color of the edge image may be modified. During the modification, a color value for changing the color of the edge image is obtained, and the obtained color value for changing the color of the edge image is multiplied by the color value of the edge image in the fragment shader, to obtain an edge image with a preset color. The edge image with the preset color is superimposed with the original acquired image, to obtain an outlined image with a target color.

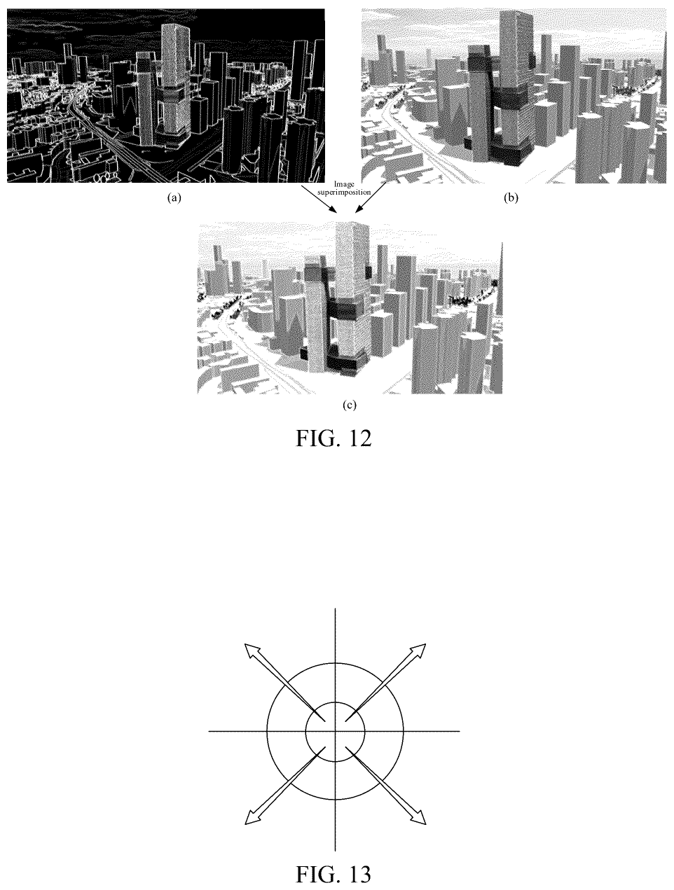

FIG. 12 is a schematic diagram of displaying of an outlined image according to some embodiments. After the color of the edge image (a) corresponding to the acquired image is modified to obtain the edge image with the preset color (for example, blue), the edge image with the preset color is superimposed with the original acquired image (b), to obtain the outlined image (c) with the target color. The outlined image with the desired target color can be conveniently obtained by customizing edge images with various colors. A user can control a effect display form in an entire AR process, thereby improving the convenience and enhancing the controllable recognition experience.

Herein, the preset color may be the same as or different from the target color. When the acquired image is a grayscale image, the target color is the same as the preset color. When the acquired image is a colored image, the target color is obtained by superimposing and blending the preset color with the color of the acquired image. The target color may be different from the preset color.

### 1.3 Production of a Scanning Animation

As shown in FIG. 5, the effective recognition range 501 and the recognition baseline 502 are displayed on the recognition interface (for example, the mobile phone screen). An image region (for example, the above sub-region) within the effective recognition range participates in outlining, and an image region beyond the effective recognition range remains unchanged. In actual application, a time parameter (for example, the above time displacement function) is added to the fragment shader for rendering the camera image, to control the position of the recognition baseline to change over time, and inform the fragment shader of which fragments (for example, pixel points in the above sub-region) need outlining at a current moment, thereby achieving a scanning animation effect.

A parameter of a recognition strength is added to the image region within the effective recognition range. The recognition strength depends on an absolute distance between a pixel point in a currently recognized image region and the recognition baseline. Recognition strengths respectively corresponding to pixel points are determined according to distances between the pixel points and the recognition baseline. For example, it is assumed that a position of a pixel point is y, a position of the recognition baseline is Sy, and a radius of the effective recognition range is r. Recognition strength I may be fitted by using the following formula:

$$I = {( r - \vert y - {S}_{y} \vert )}^{2} * {( \frac{1}{r} )}^{2} .$$

According to the above formula, in a case that r is known, a smaller absolute distance between a pixel point and the recognition baseline indicates a higher recognition strength corresponding to the pixel point and a higher corresponding superimposing and outlining strength. The superimposing and outlining strengths corresponding to the pixel points that have distances to the recognition baseline from small to large sequentially decrease until the superimposing and outlining strengths disappear (for example, no superimposing and outlining are performed), thereby achieving an animation effect that the recognition effect gradually disappears in the recognition process.

In the above method, the edge image in the camera image is extracted in real time, and the edge image is dynamically superimposed with the original image, to achieve a streaming light scanning animation effect.

### 2. Glistening Effect

A sequence frame image (for example, the above acquired image) is drawn by using an off-screen canvas, to obtain image data that may be read by the fragment shader, texture extraction is performed on the image data, to obtain an image texture (for example, a camera image texture) of the acquired image. An animation texture having a ripple density change is obtained, and the obtained animation texture is input to a texture unit corresponding to the image texture in the fragment shader, for example, the animation texture is input to the fragment shader for rendering the camera image. With reference to the camera image texture and animation texture of the sequence frame, a camera animation effect of a changing water surface is fused and presented.

### 3. Water Ripple Fluctuation Effect

Herein, an animation effect of water ripple fluctuation is still made for the camera image from the perspective of rewriting of the fragment shader. Some embodiments principle of a visual effect of water surface fluctuating diffusion is similar to stretching each pixel point in the acquired image around a fluctuation center point (for example, the above ripple diffusion center) in FIG. 13. FIG. 13 is a schematic diagram of fluctuation stretching according to some embodiments. In the fragment shader, uv coordinates of each pixel point are recalculated, and coordinate differences between original uv coordinates (for example, the above original coordinates) of each pixel point and the fluctuation center point are used as new uv coordinates of the corresponding pixel point, to sample offset coordinates of the original camera image, thus achieving an effect of stretching all pixel points on an image around the fluctuation center point.

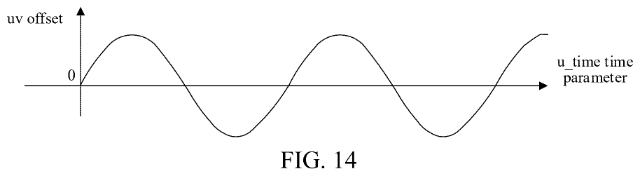

FIG. 14 is a schematic diagram of a pixel coordinate offset function according to some embodiments. A time parameter is added to the calculation of the new uv coordinates, and the pixel coordinate offset function (sine function) is configured for nesting, to dynamically change an offset of the uv coordinates, so that stretching strength of a current image periodically changes over time.

According to a rule that water ripples diffuse from the fluctuation center point, after the water ripples diffuse from the fluctuation center point, a middle part that has diffused does not fluctuate any more. A diffusion behavior of the water ripples actually is that a radius of a circle constantly increases, ripples outside the circle being effective and ripples within the circle being static. An offset parameter (configured for affecting the coordinate offsets of each pixel point in the acquired image) is added to the fragment shader, and the offset parameter is updated externally in real time like the time parameter. The updated offset parameter is transmitted to the fragment shader. The offset parameter represents a radius of a circular range of current water ripple diffusion. Each pixel point may calculate a distance between its current uv coordinates and the fluctuation center point, to determine whether the pixel point is within the circular range. The offset parameter is obtained by using a clamp (MIN, VAL, MAX) function. The clamping (MIN, VAL, MAX) is to limit VAL to a minimum value (MIN, which may be set, for example, to 0) and a maximum value (MAX, which may be set, for example, to 5). When VAL is beyond a range between the minimum value and the maximum value, a preset value is selected from the minimum value and the maximum value for use. For example, when a pixel point is located within the circular range, the offset parameter corresponding to the pixel point is the preset value (for example, VAL which may be a distance between the uv coordinates of the pixel point and the fluctuation center point). When a pixel point is not within the circular range, the offset parameter corresponding to the pixel point is the maximum value.

The new uv coordinates of each pixel point that are obtained by the coordinate differences between the original uv coordinates (for example, the above original coordinates) of each pixel point and the fluctuation center point, the offset parameter, and the pixel coordinate offset function are multiplied, to obtain the final coordinates of each pixel point. The ripple effect rendering is performed on the final coordinates of each pixel point, to obtain a water ripple (for example, the above ripple element) that performs fluctuating diffusion from the fluctuation center to the periphery. The fragment shader fuses the acquired image with the water ripple to obtain the ripple image having the ripple diffusion range change, and the ripple image is used as the recognition effect in the AR recognition process.

In the above method, in conjunction with a camera image rendering mechanism provided by the AR recognition capability in the client, the AR recognition animation is creatively directly produced in the fragment shader. For example, a series of sequence frame transparent animation textures are dynamically added to the fragment shader for rendering a camera image, to enrich images and create an AR environment atmosphere. An algorithm logic such as stretching and offsetting around the center point is added to the camera image in the fragment shader, to produce a water ripple fluctuation effect and a glistening effect, so that the camera image in the AR recognition process is more novel and interesting and more interactive, and reduces a feeling of boring in a waiting process of a user for AR recognition. High-performance processing and rendering are performed on the acquired image by the GPU. This greatly reduces the computational overheads, and phenomena such as heat, frame freezing, and frame dropping do not occur any more, thereby providing a better user experience. In some embodiments, the image edge extraction algorithm is customized in the fragment shader, thereby providing a better image edge processing effect without reference to and dependency on another image processing library, and more highlighting the advantages of simplicity and high efficiency in an environment, such as a mini program, with limited memory occupation.

The object recognition method according to some embodiments has been explained in conjunction with the exemplary applications and implementations of the electronic device according to some embodiments. The following continues to explain cooperation of modules in an object recognition apparatus 555 according to some embodiments to implement an object recognition solution.

A first display module 5551 is configured to display a recognition control, the recognition control being configured for performing augmented reality recognition on a to-be-recognized object. A second display module 5552 is configured to display a recognition interface in response to a trigger operation for the recognition control. A third display module 5553 is configured to: perform an augmented reality recognition operation on the to-be-recognized object when the to-be-recognized object exists on the recognition interface, and display a recognition effect of the to-be-recognized object in the process of performing the augmented reality recognition operation. A fourth display module 5554 is configured to display an augmented reality recognition result of the to-be-recognized object in response to the augmented reality recognition operation being completed.

In some embodiments, the third display module is further configured to: display a region in the to-be-recognized object in a target display mode, and use the used target display mode as the recognition effect of the to-be-recognized object, the target display mode being configured for indicating that augmented reality recognition is being performed on the region, and the target display mode including at least one of the following display modes: displaying the region in a preset color, displaying the region by superimposing a mask, highlighting the region, displaying the region in an outlining mode, and dynamically displaying the region.

In some embodiments, the third display module is further configured to: display, on the recognition interface, an effective recognition range and a recognition baseline within the effective recognition range; perform the augmented reality recognition operation on the to-be-recognized object when all regions in the to-be-recognized object are located within the effective recognition range; control, in the process of performing the augmented reality recognition operation, the recognition baseline to move on the to-be-recognized object; and display recognition effects respectively corresponding to sub-regions in the to-be-recognized object along with the movement of the recognition baseline, the sub-regions being divided according to distances between the sub-regions and the recognition baseline.

In some embodiments, the third display module is further configured to display the recognition effects respectively corresponding to the sub-regions in the to-be-recognized object by using different display styles, different display styles being configured for indicating different sub-regions have different recognition strengths, and the recognition strengths being in a negative correlation with the distances between the corresponding sub-regions and the recognition baseline.

In some embodiments, the third display module is further configured to: obtain a time displacement function, the time displacement function being configured for controlling the recognition baseline to move; control, according to the time displacement function, the recognition baseline to move on the to-be-recognized object, the recognition baseline located at a first position in the to-be-recognized object being configured for indicating that augmented reality recognition is being performed on a sub-region in which the first position in the to-be-recognized object is; determine a second position of the recognition baseline on the to-be-recognized object according to the time displacement function in the process of controlling the recognition baseline to move on the to-be-recognized object; and perform effect rendering on a sub-region in which the second position is, to obtain a effect rendering result, and display the effect rendering result as a recognition effect of the sub-region in which the second position is.

In some embodiments, the apparatus further includes: a fifth display module, configured to: perform an augmented reality recognition operation on partial regions in the to-be-recognized object when the partial regions in the to-be-recognized object are located within the effective recognition range; and in the process of performing the augmented reality recognition operation, display the recognition effects of the partial regions and display original content of another region in the to-be-recognized object except the partial regions, where the recognition effects include original content and corresponding effect elements of the partial regions.

In some embodiments, the third display module is further configured to: perform edge extraction on an acquired image that includes the to-be-recognized object, to obtain an edge image; and superimpose the edge image with the acquired image, to obtain an outlined image, and display the outlined image as the recognition effect of the to-be-recognized object.

In some embodiments, the third display module is further configured to: obtain a color value for changing a color of the edge image, and multiply the color value by the edge image, to obtain an edge image with a preset color; and superimpose the edge image with the preset color and the acquired image, to obtain an outlined image with a target color, and display the outlined image with the target color as the recognition effect of the to-be-recognized object.

In some embodiments, the third display module is further configured to: perform texture extraction on an acquired image that includes the to-be-recognized object, to obtain an image texture of the acquired image; obtain an animation texture having a ripple density change, and fuse the animation texture with the image texture, to obtain a ripple image having the ripple density change; and display the ripple image having the ripple density change as the recognition effect of the to-be-recognized object, where a changing ripple density is configured for indicating a recognition progress of the augmented reality recognition operation.

In some embodiments, the third display module is further configured to: obtain a ripple diffusion function, the ripple diffusion function being configured for indicating that a ripple diffusion range changes over time; obtain a ripple element that performs fluctuating diffusion from a ripple diffusion center to a periphery according to the ripple diffusion function; and fuse an acquired image corresponding to the to-be-recognized object with the ripple element, to obtain a ripple image having a ripple diffusion range change, and use the ripple image having the ripple diffusion range change as the recognition effect of the to-be-recognized object, where a changing ripple diffusion range is configured for indicating a recognition progress of the augmented reality recognition operation.

In some embodiments, the apparatus further includes: a ripple element determining module, configured to: determine an offset parameter according to the ripple diffusion function, the offset parameter being configured for affecting a coordinate offset of each pixel point in the acquired image; obtain a pixel coordinate offset function, the pixel coordinate offset function being configured for dynamically changing the coordinate offset of each pixel point in the acquired image; determine final coordinates of each pixel point according to original coordinates of each pixel point, the offset parameter, and the pixel coordinate offset function; and perform ripple effect rendering according to the final coordinates of each pixel point and the ripple diffusion function, to obtain the ripple element.

In some embodiments, the ripple element determining module is further configured to: multiply, when the ripple diffusion center is a center position of the acquired image, the original coordinates of each pixel point, the offset parameter, and the pixel coordinate offset function, to obtain the final coordinates of each pixel point; and when the ripple diffusion center is another position on the recognition interface except the center position of the acquired image, obtain coordinate differences between the original coordinates of each pixel point and the ripple diffusion center, and multiplying the coordinate differences of each pixel point, the offset parameter, and the pixel coordinate offset function, to obtain the final coordinates of each pixel point.

In some embodiments, the third display module is further configured to: perform the augmented reality recognition operation on the to-be-recognized objects when at least two to-be-recognized objects exist on the recognition interface, and display recognition effects of the to-be-recognized objects by using different display styles in the process of performing the augmented reality recognition operation. The fourth display module is further configured to respectively display augmented reality recognition results of the to-be-recognized objects.

In some embodiments, the third display module is further configured to: control, when at least two to-be-recognized objects exist on the recognition interface, the at least two to-be-recognized objects to be in a selectable state; and perform the augmented reality recognition operation on the target to-be-recognized object in response to a selection operation for a target to-be-recognized object, and display a recognition effect of the target to-be-recognized object in the process of performing the augmented reality recognition operation. The fourth display module is further configured to display an augmented reality recognition result of the target to-be-recognized object.

In some embodiments, the third display module is further configured to: perform the augmented reality recognition operation on a target to-be-recognized object when at least two to-be-recognized objects exist on the recognition interface, and display a recognition effect of the target to-be-recognized object in the process of performing the augmented reality recognition operation, where a recognition priority of the target to-be-recognized object is higher than a recognition priority of another to-be-recognized object. The fourth display module is further configured to display an augmented reality recognition result of the target to-be-recognized object.

In some embodiments, the apparatus further includes: a prediction module, configured to determine the recognition priority of the target to-be-recognized object through the following processing: determining an impact parameter for affecting the recognition priority of the target to-be-recognized object, the impact parameter including at least one of the following: a position of the target to-be-recognized object on the recognition interface, an object type to which the target to-be-recognized object belongs, a historical interaction popularity corresponding to the target to-be-recognized object, and a degree of matching between the target to-be-recognized object and a current user; and invoking a neural network model for prediction based on the impact parameter, to obtain the recognition priority of the target to-be-recognized object, the neural network model being obtained by training on an impact parameter for affecting a recognition priority of a to-be-recognized object sample and a marked recognition priority of the to-be-recognized object sample.

In some embodiments, the third display module is further configured to: display, in the process of displaying the recognition effect of the to-be-recognized object, recognition progress indication information that is displayed by using a target mode, the target mode including at least one of the following: a progress bar, a percentage, and countdown, where the recognition progress indication information is configured for indicating a recognition progress of the augmented reality recognition operation.

In some embodiments, the fourth display module is further configured to: display an augmented reality recognition result of another to-be-recognized object; or display recommendation guidance information, the recommendation guidance information being configured for guiding to view an augmented reality recognition result of another to-be-recognized object; and use the augmented reality recognition result of the another to-be-recognized object or the recommendation guidance information as the augmented reality recognition result of the to-be-recognized object, where a correlation between the another to-be-recognized object and the to-be-recognized object is greater than a correlation threshold.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

Some embodiments provide a computer program product. The computer program product includes a computer program or a computer-executable instruction. The computer program or the computer-executable instruction is stored in a computer-readable storage medium. A processor of an electronic device reads the computer-executable instruction from the computer-readable storage medium, and the processor executes the computer-executable instruction, to cause the electronic device to perform the above object recognition method according to some embodiments.

Some embodiments provide a computer-readable storage medium having a computer-executable instruction stored therein. The computer-executable instruction, when executed by a processor, causes the processor to perform the above object recognition method according to some embodiments, for example, the object recognition method shown in FIG. 3.

In some embodiments, the computer-readable storage medium may be a memory such as a ferroelectric random access memory (FRAM), a read-only memory (ROM), a programmable read-only memory (PROM), an erasable programmable read-only memory (EPROM), an electrically erasable programmable read-only memory (EEPROM), a flash memory, a magnetic surface memory, an optical disk, or a CD-ROM. The computer-readable storage medium may include one or any combination of the memories.

In some embodiments, the computer-executable instructions may be written in the form of program, software, software module, script, or code in any form of programming language (including compilation or interpretation language, or declarative or procedural language), and the computer executable instructions may be deployed in any form, including being deployed as an independent program or being deployed as a module, component, subroutine, or another unit for use in a computing environment.

In an example, the computer-executable instructions may, but do not necessarily, correspond to a file in a file system, and may be stored in a part of a file that saves another program or other data, for example, be stored in one or more scripts in a Hyper Text Markup Language (HTML) file, stored in a file that is used for a program in discussion, or stored in a plurality of collaborative files (for example, be stored in files of one or more modules, subprograms, or code parts).

In an example, the computer-executable instructions may be deployed to be executed on one electronic device, on a plurality of electronic devices located at one site, or on a plurality of electronic devices distributed at a plurality of locations and connected by a communication network.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An object recognition method of an electronic device comprising:
displaying a recognition control for performing augmented reality recognition on a to-be-recognized object;
displaying a recognition interface in response to a trigger operation for the recognition control;
performing a first augmented reality recognition operation on the to-be-recognized object based on the to-be-recognized object existing on the recognition interface, and displaying a recognition effect of the to-be-recognized object; and
displaying an augmented reality recognition result of the to-be-recognized object based on the first augmented reality recognition operation being completed.

2. The object recognition method according to claim 1, wherein the displaying the recognition effect comprises:
displaying a region in the to-be-recognized object in a target display mode, and using the target display mode as the recognition effect of the to-be-recognized object,
wherein the target display mode indicates augmented reality recognition is being performed on the region, and
wherein the target display mode comprises at least one of: displaying the region in a preset color, displaying the region by superimposing a mask, highlighting the region, displaying the region in an outlining mode, or dynamically displaying the region.

3. The object recognition method according to claim 1, wherein the performing the first augmented reality recognition operation comprises:
displaying, on the recognition interface, an effective recognition range and a recognition baseline within the effective recognition range; and
performing the first augmented reality recognition operation on the to-be-recognized object based on all regions in the to-be-recognized object being located within the effective recognition range, and
wherein the displaying the recognition effect comprises:
controlling the recognition baseline to move on the to-be-recognized object; and
displaying a plurality of recognition effects corresponding to a plurality of sub-regions in the to-be-recognized object with movement of the recognition baseline, wherein the plurality of sub-regions are divided based on a plurality of distances between the plurality of sub-regions and the recognition baseline.

4. The object recognition method according to claim 3, wherein the displaying the plurality of recognition effects comprises:
displaying the plurality of recognition effects based on a plurality of display styles,
wherein the plurality of display styles being indicate different sub-regions have different recognition strengths, and
wherein the recognition strengths are in negative correlation with the plurality of distances.

5. The object recognition method according to claim 3, wherein the controlling the recognition baseline comprises:
obtaining a time displacement function for controlling the recognition baseline to move; and
controlling, based on the time displacement function, the recognition baseline to move on the to-be-recognized object,
wherein the recognition baseline is located at a first position in the to-be-recognized object and indicates that augmented reality recognition is being performed on a first sub-region in which the first position in the to-be-recognized object is, and
wherein the displaying the plurality of recognition effects comprises:
determining a second position of the recognition baseline on the to-be-recognized object based on the time displacement function; and
performing effect rendering on a second sub-region in which the second position is, to obtain an effect rendering result, and displaying the effect rendering result as a recognition effect of the second sub-region.

6. The object recognition method according to claim 3, further comprising:
performing a second augmented reality recognition operation on a plurality of partial regions in the to-be-recognized object based on the plurality of partial regions being located within the effective recognition range,
wherein the performing the second augmented reality recognition operation comprises displaying the plurality of recognition effects of the plurality of partial regions and displaying original content of another region in the to-be-recognized object except the plurality of partial regions, and
wherein the plurality of recognition effects comprise original content and a plurality of effect elements of the plurality of partial regions.

7. The object recognition method according to claim 1, wherein the displaying the recognition effect comprises:
performing edge extraction on an acquired image that comprises the to-be-recognized object, to obtain a first edge image; and
superimposing the first edge image onto the acquired image, to obtain a first outlined image, and displaying the first outlined image as the recognition effect.

8. The object recognition method according to claim 7, wherein the superimposing the first edge image comprises:
obtaining a color value for changing a color of the first edge image, and multiplying the color value by the first edge image, to obtain a second edge image with a preset color; and
superimposing the second edge image onto the acquired image, to obtain a second outlined image with a target color, and displaying the second outlined image with the target color as the recognition effect.

9. The object recognition method according to claim 1, wherein the displaying the recognition effect comprises:
performing texture extraction on an acquired image that comprises the to-be-recognized object, to obtain an image texture of the acquired image;
obtaining an animation texture having a ripple density change, and fusing the animation texture with the image texture, to obtain a ripple image having the ripple density change; and
displaying the ripple image as the recognition effect of the to-be-recognized object, and
wherein the ripple density change indicates a recognition progress of the first augmented reality recognition operation.

10. The object recognition method according to claim 1, wherein the displaying the recognition effect comprises:
obtaining a ripple diffusion function for indicating that a ripple diffusion range changes over time;
obtaining a ripple element that performs fluctuating diffusion from a ripple diffusion center to a periphery based on the ripple diffusion function; and
fusing an acquired image that comprises the to-be-recognized object with the ripple element, to obtain a ripple image having a ripple diffusion range change, and displaying the ripple image as the recognition effect, and
wherein the ripple diffusion range change indicates a recognition progress of the first augmented reality recognition operation.

11. An object recognition apparatus, comprising:
at least one memory configured to store computer program code; and
at least one processor configured to read the program code and operate as instructed by the program code, the program code comprising:
first display code configured to cause at least one of the at least one processor to display a recognition control for performing augmented reality recognition on a to-be-recognized object;
second display code configured to cause at least one of the at least one processor to display a recognition interface in response to a trigger operation for the recognition control;
third display code configured to cause at least one of the at least one processor to:
perform a first augmented reality recognition operation on the to-be-recognized object based on the to-be-recognized object existing on the recognition interface; and
display a recognition effect of the to-be-recognized object; and
fourth display code configured to cause at least one of the at least one processor to display an augmented reality recognition result of the to-be-recognized object based on the first augmented reality recognition operation being completed.

12. The object recognition apparatus according to claim 11, wherein the third display code is configured to cause at least one of the at least one processor to display a region in the to-be-recognized object in a target display mode, and use the target display mode as the recognition effect of the to-be-recognized object,
wherein the target display mode indicates augmented reality recognition is being performed on the region, and
wherein the target display mode comprises at least one of: displaying the region in a preset color, displaying the region by superimposing a mask, highlighting the region, displaying the region in an outlining mode, or dynamically displaying the region.

13. The object recognition apparatus according to claim 11, the third display code is configured to cause at least one of the at least one processor to:
display, on the recognition interface, an effective recognition range and a recognition baseline within the effective recognition range;
perform the first augmented reality recognition operation on the to-be-recognized object based on all regions in the to-be-recognized object being located within the effective recognition range;
control the recognition baseline to move on the to-be-recognized object; and
display a plurality of recognition effects corresponding to a plurality of sub-regions in the to-be-recognized object with movement of the recognition baseline, wherein the plurality of sub-regions are divided based on a plurality of distances between the plurality of sub-regions and the recognition baseline.

14. The object recognition apparatus according to claim 13, wherein the third display code is configured to cause at least one of the at least one processor to display the plurality of recognition effects based on a plurality of display styles,
wherein the plurality of display styles being indicate different sub-regions have different recognition strengths, and
wherein the recognition strengths are in negative correlation with the plurality of distances.

15. The object recognition apparatus according to claim 13, wherein the third display code is configured to cause at least one of the at least one processor to:
obtain a time displacement function for controlling the recognition baseline to move; and
control, based on the time displacement function, the recognition baseline to move on the to-be-recognized object,
wherein the recognition baseline is located at a first position in the to-be-recognized object and indicates that augmented reality recognition is being performed on a first sub-region in which the first position in the to-be-recognized object is, and
wherein the third display code is further configured to cause at least one of the at least one processor to:
determine a second position of the recognition baseline on the to-be-recognized object based on the time displacement function; and
perform effect rendering on a second sub-region in which the second position is, to obtain an effect rendering result, and display the effect rendering result as a recognition effect of the second sub-region.

16. The object recognition apparatus according to claim 13, wherein the program code further comprises fifth display code configured to cause at least one of the at least one processor to:
perform a second augmented reality recognition operation on a plurality of partial regions in the to-be-recognized object based on the plurality of partial regions being located within the effective recognition range; and
display the plurality of recognition effects of the plurality of partial regions, and display original content of another region in the to-be-recognized object except the plurality of partial regions, and
wherein the plurality of recognition effects comprise original content and a plurality of effect elements of the plurality of partial regions.

17. The object recognition apparatus according to claim 11, wherein the third display code is configured to cause at least one of the at least one processor to:
perform edge extraction on an acquired image that comprises the to-be-recognized object, to obtain a first edge image; and
superimpose the first edge image onto the acquired image, to obtain a first outlined image, and display the first outlined image as the recognition effect.

18. The object recognition apparatus according to claim 17, wherein the third display code is configured to cause at least one of the at least one processor to:
obtain a color value for changing a color of the first edge image, and multiply the color value by the first edge image, to obtain a second edge image with a preset color; and
superimpose the second edge image onto the acquired image, to obtain a second outlined image with a target color, and display the second outlined image with the target color as the recognition effect.

19. The object recognition apparatus according to claim 11, wherein the third display code is configured to cause at least one of the at least one processor to:
perform texture extraction on an acquired image that comprises the to-be-recognized object, to obtain an image texture of the acquired image;
obtain an animation texture having a ripple density change, and fuse the animation texture with the image texture, to obtain a ripple image having the ripple density change; and
display the ripple image as the recognition effect of the to-be-recognized object, and
wherein the ripple density change indicates a recognition progress of the first augmented reality recognition operation.

20. A non-transitory computer-readable storage medium, storing computer code which, when executed by at least one processor, causes the at least one processor to at least:
display a recognition control for performing augmented reality recognition on a to-be-recognized object;
display a recognition interface in response to a trigger operation for the recognition control;
perform a first augmented reality recognition operation on the to-be-recognized object based on the to-be-recognized object existing on the recognition interface;
display a recognition effect of the to-be-recognized object; and
display an augmented reality recognition result of the to-be-recognized object based on the first augmented reality recognition operation being completed.
